(19) United States
(12) Patent Application Publication
(10) Pub. No.: US 2009/0163704 A1
(43) Pub. Date: Jun. 25, 2009

(54) Use of Acid Scavengers in Removal of Protons (Acidity) of the Reaction Mass During Chlorination of Sucrose-6-Acetate

(76) Inventors: Rakesh Ratnam, Bangalore (IN); Aurora Sundeep, Bangalore (IN); B. Chandrasekhar, Bangalore (IN); Raj Ravi, Bangalore (IN)

Correspondence Address: THE NATH LAW GROUP, 112 South West Street, Alexandria, VA, 22314, US

(21) Appl. No.: 11/992,233

(22) PCT Filed: Sep. 21, 2006
(86) PCT No.: PCT/IN2006/000383

§ 371 Date: Jul. 2, 2008

(30) Foreign Application Priority Data
Sep. 22, 2005 (IN) 1173/MUM/2005

(51) Int. Cl. C13K 13/00

(52) U.S. Cl. 536/123.13

(57) ABSTRACT

A process is described wherein efficiency of chlorination is improved in a process for production of a chlorinated sucrose by scavenging, using an acid scavenger, of excess of acidic protons formed during a chlorination reaction between 6-O-acyl sucrose in dimethylformamide and a chlorinating reagent.

### TECHNICAL FIELD

The present invention relates to a novel process and a novel strategy for production of 1′-6′-Dichloro-1′-6′-DIDEOXY-β-Fructofuranasyl-4-chloro-4-deoxy-galactopyranoside (TGS) involving use of scavengers to remove the unwanted acidic protons from the reaction mass during chlorination reaction from the reaction mass using Chemical agents called “Acid scavengers” such as soluble resins, polymer bound Resins, Zeolites, etc.

### BACKGROUND OF THE INVENTION

Majority of strategies used in prior art methods of production of 4,1′,6′trichlorogalactosucrose, abbreviated for the purpose of this specification as “TGS”, also expressed as 1′-6′-Dichloro-1′-6′-DIDEOXY-β-Fructofuranasyl-4-chloro-4-deoxy-galactopyranoside, predominantly involve chlorination of 6-O-acyl sucrose by use of Vilsmeier-Haack reagent, to form 6 acetyl 4,1′,6′trichlorogalactosucrose, using various chlorinating agents such as phosphorus oxychloride, oxalyl chloride, phosphorus pentachloride etc, and a tertiary amide such as dimethyl formamide (DMF). After the said chlorination reaction, the reaction mass is neutralized to pH 7.0-7.5 using appropriate alkali hydroxides of calcium, sodium, etc. The pH of the neutralized mass is then further raised to 9.5 or above to deacylate/deacetylate the 6 acetyl 4,1′,6′trichlorogalactosucrose to form 4,1′,6′ trichlorogalactosucrose.

The reaction of Vilsmeier reagent and 6-O-acyl sucrose, however, produces a large amount of acidic protons, which leads to lowering of the pH and also give rise to other various undesirable decomposition reactions of the reactants and products thus giving rise to unwanted impurities and lowering the yield of desired product of chlorinated sucrose.

Means of preventing the undesired side reactions was needed for achieving any improvement in efficiency of chlorination reaction.

### SUMMARY OF THE INVENTION

This invention describes a new process where for the first time, a step of removing acidic protons is used after initiation of a reaction between a chlorinating reagent and 6-O-acylsucrose in a process for preparation of a chlorinated compound. This step, surprisingly improved significantly the yield of a chlorinated sucrose compound. The said step of removing excess acid protons may be carried out by using an acid scavenger comprising one or more of a relatively inert chemical capable of binding acidic protons without reacting with a chemical in contact, further comprising without being limited to a resin, a polymer bound resin, a Zeolite and the like. The said acid scavenger could be in a free form or in an immobilized form including a polymer bound form. The said chlorinated sucrose compound includes one or more of TGS-acetate, TGS and the like. The said acid scavengers are used to scavenge excess acid protons generated in a process of production of a chlorinated sucrose compound involving use of chlorination of 6-O-acyl by using a chlorination reaction, which may involve use of a Vilsmeier reagent.

### DETAILED DESCRIPTION OF INVENTION

Present invention relates to the use of an inert chemical agent called “Acid scavenger” comprising one or more of a resin, a Zeolite and the like. The said acid scavenger may be in a free form or in an immobilized form. An immobilized form comprises one or more of a method of immobilization including binding on a polymer and the like. This acid scavenger is used to remove unwanted acidic protons from the reaction mass which are generated during a chlorination reaction carried out in a process of production of a chlorinated sucrose compound, including 6-O-protected TGS, TGS and the like, by chlorination of 6-O-acyl sucrose by a Vilsmeier reagent. Embodiments of chlorination reaction mixture which can be subjected to the process described in this invention includes, without being limited to, a process stream obtained after mixing 6-O-acyl sucrose with a chlorinating agent, usually a Vilsmeier reagent, in one or more of a process for production of TGS or TGS-6-acetate as described in Mufti et al. (1983) U.S. Pat. No. 4,380,476, Walkup et al. (1990 U.S. Pat. No. 4,980,463), Jenner et al. (1982) U.S. Pat. No. 4,362,869, Tulley et al. (1989) U.S. Pat. No. 4,801,700, Rathbone et al. (1989) U.S. Pat. No. 4,826,962, Bornemann et al. (1992) U.S. Pat. No. 5,141,860, Navia et al. (1996) U.S. Pat. No. 5,498,709, Simpson (1989) U.S. Pat. No. 4,889,928, Navia (1990) U.S. Pat. No. 4,950,746, Neiditch et al. (1991) U.S. Pat. No. 5,023,329, Walkup et al. (1992) 5,089,608, Dordick et al. (1992) U.S. Pat. No. 5,128,248, Khan et al. (1995) U.S. Pat. No. 5,440,026, Palmer et al. (1995) U.S. Pat. No. 5,445,951, Sankey et al. (1995) U.S. Pat. No. 5,449,772, Sankey et al. (1995) U.S. Pat. No. 5,470,969, Navia et al. (1996) U.S. Pat. No. 5,498,709, Navia et al. (1996) U.S. Pat. No. 5,530,106

Vilsmeir reagent used may be of a general formula HClC═N.sup.+ R.sub.2 ]Cl.sup.− where R represents an alkyl group, typically a methyl or ethyl group, by one or more of a method of its preparation by reacting a tertiary amide, preferably DMF, with an acid chloride or [Bis(trichloromethyl) carbonate] (C₃O₃Cl₆) or phosgene (COCl₂) or thionyl chloride (SOCl₂) including a method of reacting DMF with Phosphorus Pentachloride or ethanedioyl chloride with DMF.

Vilsmeier reagent used in this invention may also be of a general formula [HPOCl.sub.2.O.C.sup+═N.sup+.R.sub.2] Cl.sup.− where R represents an alkyl group, typically a methyl or ethyl group-prepared by reacting a tertiary amide, preferably DMF, with phosphorus oxychloride by a method described in patent application no. PCT/IN06/00151.

Formation of excess acidic protons may be encountered in other instances of reaction of sucrose with a chlorinating agent too, such as when sucrose is reacted in pyridine with thionyl chloride or sucrose pentaacetate with triphenylphosphine in the presence of 1,1,2-trichloroethane

Polymer bound Scavengers are an important tool for the removal of excess protons in solution phase combinational chemistry. The excess acidity caused in some reactions leads to decomposition of reactants or products formed, which is highly undesirable. The use of an alkali for the removal of excess of acid is also not possible because in addition to reacting with protons, an alkali will also react with other constituents of a reaction mixture which also is undesirable at that stage of the process of production. The remedy to this situation and formation of the said decomposition products was regarded as unavoidable integral part of the reaction which could be dealt with only by removal of these undesired products during isolation and purification process. It is for the first time that a step of removal of the excess acid protons is introduced in the said chlorination process, it is for the first time that for that step as applied to a process of production of a chlorinated sucrose compound, an acid scavenger comprising of a resin or a zeolite and the like is used.

A polymeric resin in particular, with suitable crosslinking serves as a relatively highly inert matrix and serves the purpose of effective neutralization restricting itself for reacting with a free acidic proton alone and not with a chemical constituent of a reaction mixture. These resins have “Scavenger pore”, which is an expression describing capability of a resin to scavenge free acidic protons, the size of which is related to amount of protons that can be scavenged. Usually a macroporous resin with high crosslinking have a scavenger pore of a good capacity for this purpose and is more preferable for such reactions. A macro porous high cross-linked polystyrene/DVB matrix is particularly suitable for this purpose. The permanent porosity provides a broad range of solvent compatibility. In contrast to standard gel type low cross linked polystyrene/DVB resins, swelling is reduced significantly. To make filtration of the resin easy, the particle size is 200-400 micron.

During the preparation of Vilsmeier reagent (chloroformiminium chloride) by reacting PCl₅ with Dimethylformamide (DMF), POCl₃ gets generated, which in turn reacts with DMF to form another Vilsmeier reagent and gets combined with the already formed Vilsmeier reagent in the same reaction mixture. Combined Vilsmeier reagent from PCl₅ and POCl₃ is a subject matter of a patent application PCT/IN06/00152. The said combined Vilsmeier reagent is formed when 1.2 to 1.7 molar equivalents of PCl₅ was added to DMF taken in excess (6.3 to 7.0 molar equivalents) at ambient temperature slowly under stirring. PCl₅ reacts with DMF to form the Vilsmeier Haack reagent accompanying the formation of POCl₃. The POCl₃ reacts with the excess DMF available and also forms a Vilsmeier reagent. The reaction is kept under stirring for 1-5 hours wherein the Vilsmeier formation is complete and is in mixed condition. Then the reaction mass is cooled to 0-5° C. and then the sucrose-6-acetate (0.15 molar equivalent) dissolved in DMF is added slowly under stirring, Acidic protons are generated as result of the complex formed between the Vilsmeier and the sucrose-6-aster. These acidic protons reduce the yield of chlorinated sucrose. These protons, thus produced, reduce the pH of the reaction mass and hence the chlorination yields are greatly affected. These acidic protons give rise to other various undesirable decomposition reactions of the reactants and products thus giving rise to unwanted impurities

The removal of acidic protons was never anticipated as dramatically useful a step so far until applied in this invention in the synthesis strategy for TGS. It has been found that this can indeed be useful and the removal of acidic protons can be carried out separately before heating the reaction mass to elevated temperatures for the chlorination to occur. However, the specific resins/other acid scavengers used should be stable to DMF and also to the temperatures above 100° C.

The conventional organic bases like ter-alkyl amines, tri ethylamine (TEA), tri-butylamine and morpholine bases, if used, bind the reactive chlorine atom of the Vilsmeier complex, thereby reducing the strength of the reagent. This greatly reduces the chlorination efficiencies. In addition to this, these amines can also react with organically bound chlorines of the chlorosucrose derivatives formed in the reaction, leading to the formation of anhydrosucrose derivatives, which if present, makes the purification process difficult.

The above problems could be successfully overcome by the use of highly crosslinkded macroporous Polystyrene resin/DVB resin matrix, which are widely used to remove excess acidic protons in solution/solid phase chemistry. The permanent porosity of these resins, provides a broad range of solvent compatibility. The Macroporous polystyrene resin having different functional groups such as, amino methyl group, benzyl isocyanate, phenethyldiethylamine, phenethylmorpholine, phenethyl morpholine, phenethyl piperidine, sodium form of benzene sulfonic acid are used as acid scavengers. The quantity of resin used for proton removal is in the range of 0.05-1.0 w/w of 6-O-acylsucrose—input for chlorination. The specific ratio differs from resin to resin.

After achieving chlorination, either TGS-6-acetate can be isolated and purified using one or more of a step of purification of 6-O-protectedTGS—comprising drying, extractive purification, chromatographic purification and the like, or TGS can be obtained by deacylation by neutralizing the reaction mass by adding an alkali, preferably a slurry of an alkaline earth metal hydroxide in water, further preferably of a sodium hydroxide or calcium hydroxide, to a pH of around 7, more preferably to a pH of around 5 to 6.5 followed by one or more of a step of isolation and/or purification of TGS comprising drying, extractive purification, chromatographic purification and the like.

Described in the following are examples, which illustrate working of this invention without limiting the scope of this invention in any manner. Reactants, proportion of reactants used, range of reaction conditions described are only illustrative and the scope extends to their analogous reactants, reaction conditions and reactions of analogous generic nature. In general, any equivalent alternative which is obvious to a person skilled in art of chlorinated sucrose production is covered within the scope of this specification. This invention also covers organic reactions in general where drift of pH towards acidic side during the course of a non-aqueous reaction or the acidity present or developed for any reason is desired to be neutralized and pH raised to 7, around 7 or above without external addition of water with the pH adjusting agent. Mention in singular is construed to cover its plural also, unless the context does not permit so, viz: use of “an organic solvent” for extraction covers use of one or more of an organic solvent in succession or in a combination as a mixture.

### Example 1

### sucrose-6-acetate Chlorination without Acid Scavenger Resin

635 g of PCl₅ was added to a round bottom flask containing 1280 ml of at 20° C. The Vilsmeier formation was observed by the formation of white crystals of Vilsmeier reagent. After about 15 min, the liberated POCl₃ also started forming the Vilsmeier and formed an orange red solution along with the solid. The mixture was then stirred thoroughly for 1.0 hr at room temperature. The mixture was cooled to 0° C. and the sucrose-6-acetate (150 g) in DMF was added drop wise. The temperature was maintained below 0° C. during addition. After the completion of addition of the substrate, the temperature was allowed to ambient and stirred for 1.0 hr.

The temperature was then raised to 65° C., maintained for 1.5 hrs and further heated to 80° C. and maintained for 1.0 hr. Further the temperature was raised up to 115° C. and maintained for 3½ hrs. The reaction mass was then neutralized using Sodium hydroxide slurry up to pH 5.0-6.5. The formation of 4,1′,6′trichlorogalactosucrose was evaluated by HPLC and the yields were found to be 42% of Sucrose input.

### Example 2

### sucrose-6-acetate Chlorination Using Polymer Bound Phenethyldiethylamine

In an experiment, 635 g of PCl₅ was added to a round bottom flask containing 1280 ml of at 20° C. The Vilsmeier formation was observed by the formation of white crystals of Vilsmeier reagent. After about 15 min, the liberated POCl₃ also started forming the Vilsmeier and formed an orange red solution along with the solid. The mixture was then stirred thoroughly for 1.0 hr at room temperature. The mixture was cooled to 0° C. and the sucrose-6-acetate (150 g) in DMF was added drop wise. The temperature was maintained below 0° C. during addition. After the completion of addition of the substrate, the temperature was allowed to come to an ambient temperature and stirred for 1.0 hr.

The reaction mass is treated with 45 g of polymer bound Phenethyl diethylamine (Scavenge Pore—SC11208, RAPP POLYMERE, GmbH). It is filtered and taken for further chlorination.

The temperature was then raised to 65° C., maintained for 1.5 hrs and further heated to 80° C. and maintained for 1.0 hr. Further the temperature was raised up to 115° C. and maintained for 3½ hrs. The reaction mass was then neutralized using calcium hydroxide slurry up to pH 7.0-7.5. The formation of 4,1′,6′trichlorogalactosucrose was evaluated by HPLC and the yields were found to be 58% of Sucrose input.

### Example 3

### Sucrose-6-acetate Chlorination Using Phenethyl Morpholine Resin

In another experiment, 635 g of PCl₅ was added to a round bottom flask containing 1280 ml of at 20° C. The Vilsmeier formation was observed by the formation of white crystals of Vilsmeier reagent. After about 15 min, the liberated POCl₃ also started forming the Vilsmeier and formed an orange red solution along with the solid. The mixture was then stirred thoroughly for 1.0 hr at room temperature. The mixture was cooled to 0° C. and the sucrose-6-acetate (150 g) in DMF was added drop wise. The temperature was maintained below 0° C. during addition. After the completion of addition of the substrate, the temperature was allowed to ambient and stirred for 1.0 hr.

To the reaction mass, added 20 g of polymer bound Phenethyl morpholine (Scavenge Pore—SC11209, RAPP POLYMERE, GmbH). The temperature was then raised to 65° C., maintained for 1.5 hrs and further heated to 80° C. and maintained for 1.0 hr. Further the temperature was raised up to 115° C. and maintained for 3½ hrs. The reaction mass was then neutralized using Sodium hydroxide slurry up to pH 5.0-6.5. The formation of 4,1′,6′trichlorogalactosucrose was evaluated by HPLC and the yields were found to be 62% of Sucrose input. The resin is removed by filtration and is send for regeneration.

The TGS thus formed is taken up for further purification and isolation.

### Example 4

### Sucrose-6-acetate Chlorination Using Hydroxymethyl Cellulose Sodium Form

635 g of PCl₅ was added to a round bottom flask containing 1280 ml of at 20° C. The Vilsmeier formation was observed by the formation of white crystals of Vilsmeier reagent. After about 15 min, the liberated POCl₃ also started forming the Vilsmeier and formed an orange red solution along with the solid. The mixture was then stirred thoroughly for 1.0 hr at room temperature. The mixture was cooled to 0° C. and the sucrose-6-acetate (150 g) in DMF was added drop wise. The temperature was maintained below 0° C. during addition. After the completion of addition of the substrate, the temperature was allowed to ambient and stirred for 1.0 hr.

To the reaction mass, 45 g of hydroxymethyl cellulose in sodium form was added. The temperature was then raised to 65° C., maintained for 1.5 hrs and further heated to 80° C. and maintained for 1.0 hr. Further the temperature was raised up to 115° C. and maintained for 3½ hrs. The reaction mass was then neutralized using Sodium hydroxide slurry up to pH 5.0-6.5. The formation of 4,1′,6′trichlorogalactosucrose was evaluated by HPLC and the yields were found to be 62% of Sucrose input. The hydroxy methyl cellulose is removed by filtration.

The TGS thus formed is taken up for further purification and isolation.

### Example 5

### Sucrose-6-acetate Chlorination by Thionyl Chloride, Pyridine Reaction

Sucrose 6-acetate (200 g; purity about 78%) was dissolved in pyridine (450 ml). This solution was added to a flask containing thionyl chloride (520 ml) in 1,1,2-trichloroethane (TCE, 1160 ml) under stirring at temperature 35.degree C.

The reaction mixture was then heated to reflux over 2 hours and held at reflux (115.degree. C.) for 90 minutes. The mixture was then cooled to about 60.degree. C. and was neutralized with ammonia solution in water. The phases were separated and filtered.

The TGS thus formed (26%) is taken up for further purification and isolation.

### Example 6

### Sucrose-6-acetate Chlorination by Thionyl Chloride, Pyridine Reaction Using Phenethyl Morpholine Resin

Sucrose 6-acetate (200 g; purity about 78%) was dissolved in pyridine (450 ml). This solution was added to a flask containing thionyl chloride (520 ml) in 1,1,2-trichloroethane (TCE, 1160 ml) under stirring at temperature 35.degree. C. 40 g of polymer bound Phenethyl morpholine (Scavenge Pore—SC11209, RAPP POLYMERE, GmbH) was added to the mixture. The reaction mixture was then heated to reflux over 2 hours and held at reflux (115.degree. C.) for 90 minutes. The mixture was then cooled to about 60.degree. C. and was neutralized with ammonia solution in water. The phases were separated and filtered to recover the resin.

The TGS thus formed (35%) is taken up for further purification and isolation.

### Example 7

### 2,3,6,3′,4′-penta-O-acetyl Sucrose Chlorination by Triphenylphosphine Oxide

200 g of 2,3,6,3′,4′-penta-O-acetyl sucrose and 410 g of triphenylphosphine oxide was added to excess of 1,2-dichloroethane and stirred well. Then 450 ml of thionyl chloride was added at ambient and the mixture was stirred well. Then the reaction mass was heated to 80° C. and maintained for 90 minutes. The solution was neutralized by calcium hydroxide slurry in water. The solution was filtered to remove the extraeneous solids and resin. The biphasic layer was separated and the isolation of 4,1′,6′-trichloro-4,1′,6′-trideoxy-2,3,6,3′,4′-penta-O-acetyl-galactosucrose and deacetylation was carried out by suitable methods. The yield of chlorination was found to be 36%

### Example 8

### 2,3,6,3′,4′-penta-O-acetyl Sucrose Chlorination by Triphenylphosphine Oxide Using Phenethyl Morpholine Resin

200 g of 2,3,6,3′,4′-penta-O-acetyl sucrose and 410 g of triphenylphosphine oxide was added to excess of 1,2-dichloroethane and stirred well. Then 450 ml of thionyl chloride was added at ambient and the mixture was stirred well

15 g of Phenethyl Morpholine resin was added and was heated to reflux for 3 hours. The solution was neutralized by calcium hydroxide slurry in water. The solution was filtered to remove the extraeneous solids and resin. The biphasic layer was separated and the isolation of 4,1′,6′-trichloro-4,1′,6′-trideoxy-2,3,6,3′,4′-penta-O-acetyl-galactosucrose and deacetylation was carried out by suitable methods. The yield of chlorination was found to be 52%

1. A process of production of a chlorinated sucrose compound comprising steps of:
a. reacting f 6-O-protected sucrose dissolved in a solvent with a chlorinating agent,
b. contacting the reaction mixture with an acid scavenger, the said acid scavenger comprising one or more of a relatively inert chemical capable of binding acidic protons without reacting with a chemical in contact,
c. optionally removing the acid scavenger form the reaction mixture,
d. heating the mixture further to achieve completion of the chlorination reaction, and
e. subjecting the reaction mixture of step (d.) to one or more of a further process step to obtain, isolate and purify desired chlorinated sucrose compound.

2. A process of claim 1 wherein:
a. the said chlorinated sucrose compound comprises one or more of a chlorinated sucrose and their derivatives including one or more of a trichlorogalactosucrose with chemical formula I-6-Dichloro-1-6-DIDEOXY-β-Fructofuranosyl-4-chloro-4-deoxy-galactopyranoside abbreviated as TGS, a di chloro sucrose, a tetrachloro sucrose and the like,
b. the said acyl derivatives of sucrose comprises one or more of an acylate of sucrose including a sucrose-6-acetate, sucrose-6-benzoate, sucrose-6-propionate, sucrose-6-laurate, sucrose-6-glutarate, Sucrose 6 palmitate, 2,3,6,3′,4′-penta-O-acetyl sucrose and the like,
c. the said solvent comprises a tertiary amide, preferably a dimethylformamide, abbreviated as DMF,
d. the said chlorinating reagent is selected from a group comprising (i) thionyl chloride and a nitrogen base of free hydroxyl(pyridine or alkyl pyridine) in a non-reactive moderately polar solvent preferably a chlorinated hydrocarbon, or (ii) one or more of a Vilsmeier reagent of general formula including HClC═N.sup.+ R.sub.2 ]Cl.sup.− where R represents an alkyl group, typically a methyl or ethyl group, or [HPOCl.sub.2.O.C.sup+═N.sup+.R.sub.2] Cl.sup.− where R represents an alkyl group, typically a methyl or ethyl group,
e. the said acid scavenger being selected from a group of an acid scavenger comprising a resin, a zeolite, hydroxymethyl cellulose in sodium/potassium form and the like, in a free or polymer bound form, which further preferably includes a macro porous high cross-linked polystyrene/DVB matrix including one or more of a Phenethyl diethylamine (Scavenge Pore—SC11208, RAPP POLYMERE, GmbH), a Phenethyl morpholine (Scavenge Pore—SC11209, RAPP POLYMERE, GmbH) and the like,
f. the said heating of the mixture further in claim 1 (d.) comprises of (i) raising temperature to around 65° C., maintaining at that temperature for a period of time, preferably for around 1.5 hrs, (ii) further heating to around 80° C., maintaining at that temperature for a period of time, preferably for around 1.0 hr., (iii) further heating to around 115° C. and maintaining at that temperature for a period of time, preferably for around 3½ hrs,
g. the one or more of a further process step to obtain, isolate and purify desired chlorinated sucrose compound said in claim 1 (e.) comprises one or more of following steps: (i) isolation of 6-O-protected TGS—from the reaction mixture obtained after step of claim 1 (e) by one or more of a steps for isolation and purification of 6-O-protected TGS—comprising direct drying under mild heating conditions that do not generate caramelization, extractive purification, chromatographic purification and the like, or (ii) neutralizing the reaction mass by adding an alkali, preferably a slurry of an alkaline earth metal hydroxide in water, further preferably of a sodium hydroxide or calcium hydroxide, to a pH of around 7, more preferably to a pH of around 5 to 6.5 to de-acylate and achieve formation of TGS, (iii) followed by one or more of a step of isolation and/or purification of TGS comprising drying, extractive purification, chromatographic purification and the like.
